(19) United States
(12) Patent Application Publication
(10) Pub. No.: US 2026/0153036 A1
(43) Pub. Date: Jun. 4, 2026

(54) TURBINE ENGINE VANE STRUCTURE SEGMENT WITH RETAINING TAB

(71) Applicant: RTX Corporation, Farmington, CT (US)

(72) Inventors: Russell J. Bergman, South Windsor, CT (US); Raymond Surace, Newington, CT (US)

(21) Appl. No.: 18/965,631

(22) Filed: Dec. 2, 2024

(51) Int. Cl. F01D 11/00

(52) U.S. Cl. CPC F01D 11/001; F01D 9/04; F05D 2240/12; F05D 2240/55

(57) ABSTRACT

A turbine engine assembly includes a vane structure and an inner structure. The vane structure includes a plurality of structure segments arranged circumferentially about an axis.

Each of the structure segments includes an inner platform segment, an outer platform segment and an airfoil. The inner platform segment includes a base and a tab. The tab is connected to and projects laterally out from the base. The tab is radially next to and extends laterally along the base of the inner platform segment of a respective circumferentially neighboring one of the structure segments. The airfoil extends radially across a flowpath and is connected to the inner platform segment and the outer platform segment. The inner structure extends circumferentially around the axis. The inner structure is configured with a plurality of pins. Each of the pins projecting axially into an aperture in the base of a respective one of the structure segments.

### GOVERNMENT LICENSE RIGHTS

This invention was made with Government support under Contract N00019-21-G-0005; DO N00019-23-F-0019 awarded by the United States Navy. The Government has certain rights in this invention.

### BACKGROUND OF THE DISCLOSURE

### 1. Technical Field

This disclosure relates generally to a turbine engine and, more particularly, to a turbine vane structure for the turbine engine.

### 2. Background Information

A gas turbine engine such as a turbofan engine may include multiple vane structures within its turbine section. Various types and configurations of turbine section vane structures are known in the art. While these known turbine section vane structures have various benefits, there is still room in the art for improvement.

### SUMMARY OF THE DISCLOSURE

According to an aspect of the present disclosure, an assembly is provided for a turbine engine. This assembly includes a vane structure and an inner structure. The vane structure includes a plurality of structure segments arranged circumferentially about an axis. Each of the structure segments includes an inner platform segment, an outer platform segment and an airfoil. The inner platform segment includes a base and a tab. The base forms a respective circumferential section of an inner peripheral boundary of a flowpath through the vane structure. The tab is connected to and projects laterally out from the base. The tab is radially next to and extends laterally along the base of the inner platform segment of a respective circumferentially neighboring one of the structure segments. The outer platform segment forms a respective circumferential section of an outer peripheral boundary of the flowpath through the vane structure. The airfoil extends radially across the flowpath and is connected to the inner platform segment and the outer platform segment. The inner structure extends circumferentially around the axis. The inner structure is configured with a plurality of pins. Each of the pins projecting axially into an aperture in the base of a respective one of the structure segments.

According to another aspect of the present disclosure, another assembly is provided for a turbine engine. This assembly includes a plurality of structure segments arranged circumferentially about an axis to form a vane structure. Each of the structure segments includes an inner platform segment, an outer platform segment and an airfoil. The inner platform segment includes a base and a tab. The base forms a respective circumferential section of an inner peripheral boundary of a flowpath through the vane structure. The tab is connected to and projects laterally out from the base. An overall axial width of the tab is equal to or less than one-quarter of an overall axial length of the base. The tab is radially next to and extends laterally along the base of the inner platform segment of a respective circumferentially neighboring one of the structure segments. The outer platform segment forms a respective circumferential section of an outer peripheral boundary of the flowpath through the vane structure. The airfoil extends radially across the flowpath and is connected to the inner platform segment and the outer platform segment.

According to still another aspect of the present disclosure, another assembly is provided for a turbine engine. This assembly includes a plurality of structure segments arranged circumferentially about an axis to form a vane structure. Each of the structure segments includes an inner platform segment, an outer platform segment and an airfoil. The inner platform segment includes a wall, a flange and a tab. The wall forms a respective circumferential section of an inner peripheral boundary of a flowpath through the vane structure. The flange projects radially inward towards the axis from the wall to an inner end of the flange. The flange extends circumferentially about the axis between opposing circumferential sides of the inner platform segment. The tab is connected to and projects laterally out from the flange. The tab is radially adjacent, inboard of and extends laterally along the flange of the inner platform segment of a respective circumferentially neighboring one of the structure segments. The outer platform segment forms a respective circumferential section of an outer peripheral boundary of the flowpath through the vane structure. The airfoil extends radially across the flowpath and is connected to the inner platform segment and the outer platform segment.

The tab may be configured to limit radial outward movement of the inner platform segment that includes the tab.

The tab may be radially inboard of the base of the inner platform segment of the respective circumferentially neighboring one of the structure segments.

An axial width of the tab may be equal to or less than one-quarter of an axial length of the base.

The base may include a wall and a first flange. The wall may form the respective circumferential section of the inner peripheral boundary of the flowpath through the vane structure. The first flange may project radially inward from the wall to an inner end of the first flange. The first flange may extend circumferentially about the axis between opposing circumferential sides of the wall. The tab may be connected to the first flange at the inner end of the first flange.

The base may also include a second flange projecting radially inward from the wall to an inner end of the second flange. The second flange may extend circumferentially about the axis between the opposing circumferential sides of the wall. The second flange may be axially spaced from the first flange.

The first flange may be axially aligned in proximity to a leading edge of the airfoil.

Each of the structure segments may be configured as a singlet vane structure.

Each of the structure segments may be formed as a monolithic body.

The inner structure may have a full-hoop body.

The inner structure may be configured as or otherwise include a stationary air seal land.

The assembly may also include a rotor disk rotatable about the axis, a plurality of rotor blades and a rotating air seal element. The rotor blades may be arranged circumferentially about the axis and connected to the rotor disk. Each of the rotor blades may project radially into the flowpath. The rotating air seal element may be connected to the rotor disk. The rotating air seal element may be radially below and sealingly engaged with the stationary air seal land.

The pins may be mechanically fastened to the inner structure.

The aperture may be configured as or otherwise include a slot.

The aperture may project in a radial outward direction partially into the base of the respective one of the structure segments. The aperture may extend laterally within the base of the respective one of the structure segments.

Each of the pins may be configured to limit radial inward movement of the base of the respective one of the structure segments.

The vane structure may be a turbine vane structure.

The assembly may also include a first bladed rotor stage and a second bladed rotor stage. The first bladed rotor stage may be rotatable about the axis. The first bladed rotor stage may include a first rotor disk and a plurality of first rotor blades. Each of the first rotor blades may project radially into the flowpath. The second bladed rotor stage may be rotatable about the axis. The second bladed rotor stage may include a second rotor disk and a plurality of second rotor blades. Each of the second rotor blades may project radially into the flowpath. The vane structure may be axially between and adjacent the first bladed rotor stage and the second bladed rotor stage.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial schematic sectional illustration of an aircraft powerplant.

FIG. 2 is a partial sectional illustration of a turbine section engine assembly.

FIG. 3 is a schematic end view illustration of a turbine vane structure.

FIG. 4 is a partial side sectional illustration of the turbine vane structure mated with an inner structure such as an inner air seal plate.

FIG. 5 is an end view illustration of a pair of vane structure segments.

FIG. 6 is a cross-sectional illustration of a turbine vane airfoil.

FIG. 7 is another partial side sectional illustration of the turbine vane structure mated with the inner structure.

### DETAILED DESCRIPTION

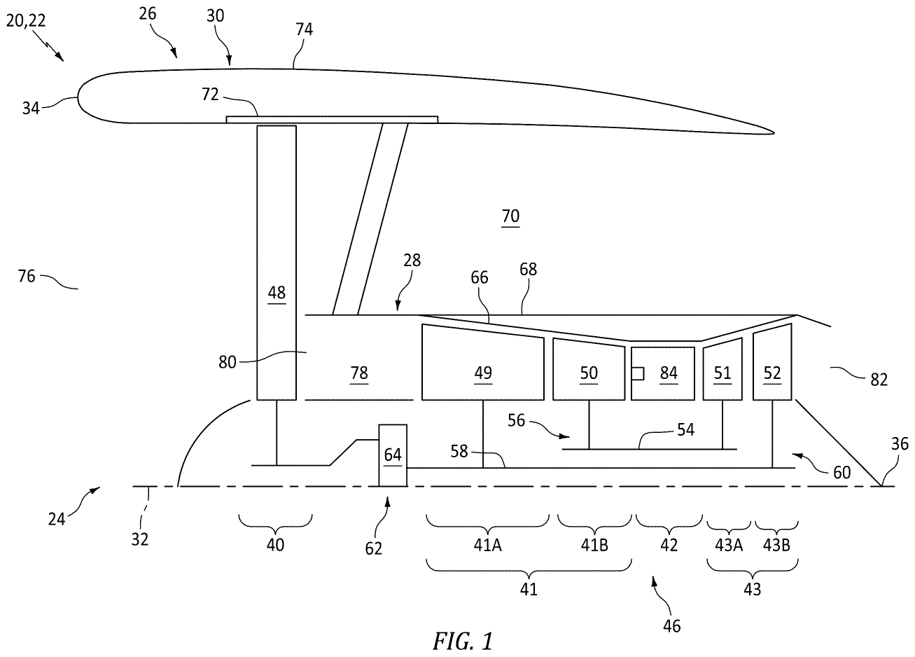

FIG. 1 illustrates a powerplant 20 for an aircraft. The aircraft may be an airplane, a drone (e.g., an unmanned aerial vehicle (UAV)) or any other manned or unmanned aerial vehicle or system. For ease of description, the aircraft powerplant 20 is described below as a propulsion system 22 for the aircraft and, more particularly, as a turbofan propulsion system.

The aircraft powerplant 20 of the present disclosure, however, is not limited to such an exemplary propulsion system. The aircraft propulsion system 22, for example, may alternatively be configured as a turbojet propulsion system, a turboprop propulsion system, a turboshaft propulsion system, a propfan propulsion system, a pusher fan propulsion system, or any other type of ducted or open rotor propulsion system. Moreover, the aircraft powerplant 20 is not limited to propulsion system applications. The aircraft powerplant 20, for example, may alternatively (or also) be configured as an electrical power system for the aircraft (e.g., an auxiliary power unit (APU)) or a ground-based (e.g., industrial) electrical power system.

The aircraft propulsion system 22 includes a gas turbine engine 24 (e.g., a turbofan engine) housed within a stationary engine housing 26, which engine housing 26 of FIG. 1 includes an inner housing structure 28 and an outer housing structure 30. The aircraft propulsion system 22 extends axially along an axis 32 between an axial forward, upstream end 34 of the aircraft propulsion system 22 and an axial aft, downstream end 36 of the aircraft propulsion system 22. Briefly, the powerplant axis 32 may be a centerline axis of the aircraft propulsion system 22, the turbine engine 24 and/or one or more of its members. The powerplant axis 32 may also or alternatively be a rotational axis for one or more members of the turbine engine 24.

The aircraft propulsion system 22 and its turbine engine 24 of FIG. 1 includes a propulsor section 40 (e.g., a fan section), a compressor section 41, a combustor section 42 and a turbine section 43. The compressor section 41 of FIG. 1 includes a low pressure compressor (LPC) section 41A and a high pressure compressor (HPC) section 41B. The turbine section 43 of FIG. 1 includes a high pressure turbine (HPT) section 43A and a low pressure turbine (LPT) section 43B. Here, at least (or only) the LPC section 41A, the HPC section 41B, the combustor section 42, the HPT section 43A and the LPT section 43B collectively form a core 46 of the turbine engine 24.

The engine sections 40-43B may be arranged sequentially along the powerplant axis 32 within the engine housing 26. The propulsor section 40 includes a bladed propulsor rotor 48; e.g., a fan rotor. The LPC section 41A includes a bladed low pressure compressor (LPC) rotor 49. The HPC section 41B includes a bladed high pressure compressor (HPC) rotor 50. The HPT section 43A includes a bladed high pressure turbine (HPT) rotor 51. The LPT section 43B includes a bladed low pressure turbine (LPT) rotor 52.

The HPC rotor 50 is coupled to and rotatable with the HPT rotor 51. The HPC rotor 50 of FIG. 1, for example, is connected to the HPT rotor 51 through a high speed shaft 54. At least (or only) the HPC rotor 50, the HPT rotor 51 and the high speed shaft 54 collectively form a high speed rotating structure 56; e.g., a high speed spool of the engine core 46. This high speed rotating structure 56 of FIG. 1 and its members 50, 51 and 54 are rotatable about the powerplant axis 32.

The LPC rotor 49 is coupled to and rotatable with the LPT rotor 52. The LPC rotor 49 of FIG. 1, for example, is connected to the LPT rotor 52 through a low speed shaft 58. At least (or only) the LPC rotor 49, the LPT rotor 52 and the low speed shaft 58 collectively form a low speed rotating structure 60; e.g., a low speed spool of the engine core 46. This low speed rotating structure 60 is further coupled to the propulsor rotor 48 through a drivetrain 62.

The drivetrain 62 may be configured as a geared drivetrain, where a geartrain 64 (e.g., a transmission, a speed change device, an epicyclic geartrain, etc.) is disposed between and operatively couples the propulsor rotor 48 to the low speed rotating structure 60 and its LPT rotor 52. With this arrangement, the propulsor rotor 48 may rotate at a different (e.g., slower) rotational speed than the low speed rotating structure 60 and its LPT rotor 52. Alternatively, the drivetrain 62 may be configured as a direct-drive drivetrain, where the geartrain 64 is omitted. With such an arrangement, the propulsor rotor 48 rotates at a common (the same) rotational speed as the low speed rotating structure 60 and its LPT rotor 52. The low speed rotating structure 60 of FIG. 1 and its members 49, 52 and 58 as well as the propulsor rotor 48 are rotatable about the powerplant axis 32. However, it is contemplated the low speed rotating structure 60 may alternatively be rotatable about another axis radially and/or angularly offset from the rotational axis of the propulsor rotor 48 and/or the centerline axis of the turbine engine 24.

The inner housing structure 28 of FIG. 1 includes an inner case 66 (e.g., a core case) for the turbine engine 24 and an inner nacelle structure 68 (sometimes referred to as an inner fixed structure (IFS)). The inner case 66 is disposed radially outboard of, extends axially along and may circumscribe one or more or all of the engine sections 41A-43B and their respective engine rotors 49-52. The inner case 66 may thereby house and provide a support structure for the respective engine sections 41A-43B and their respective engine rotors 49-52.

The inner nacelle structure 68 is configured to provide an aerodynamic cover over the engine core 46 and its inner case 66. The inner housing structure 28 and its inner nacelle structure 68 may also form a radial inner peripheral boundary of a bypass flowpath 70 (e.g., an annular bypass flowpath) within the aircraft propulsion system 22.

The outer housing structure 30 of FIG. 1 includes an outer case 72 (e.g., a fan case) for the turbine engine 24 and an outer nacelle structure 74. The outer case 72 is disposed radially outboard of, extends axially along and may circumscribe the propulsor section 40 and its propulsor rotor 48. The outer case 72 may thereby house and provide a containment structure for the propulsor section 40 and its propulsor rotor 48. The outer nacelle structure 74 is configured to provide an aerodynamic cover over the outer case 72. The outer housing structure 30 and its outer nacelle structure 74 may also form a radial outer peripheral boundary of the bypass flowpath 70.

During operation, ambient air from outside of the aircraft enters the aircraft propulsion system 22 and its turbine engine 24 through an airflow inlet 76. This air is directed across the propulsor section 40 and into a core flowpath 78 (e.g., annular core flowpath) and the bypass flowpath 70. The core flowpath 78 of FIG. 1 extends sequentially through the LPC section 41A, the HPC section 41B, the combustor section 42, the HPT section 43A and the LPT section 43B from an airflow inlet 80 into the core flowpath 78 to a combustion products exhaust 82 out from the core flowpath 78. The air entering the core flowpath 78 may be referred to as “core air”. The bypass flowpath 70 extends through a bypass duct, which bypass flowpath 70 and bypass duct bypass (e.g., are disposed radially outboard of and extend along) the engine core 46 and the inner housing structure 28. The air within the bypass flowpath 70 may be referred to as “bypass air”.

The core air is compressed by the LPC rotor 49 and the HPC rotor 50 and is directed into a combustion chamber 84 (e.g., an annular combustion chamber) of a combustor (e.g., an annular combustor) in the combustor section 42. Fuel is injected into the combustion chamber 84 by one or more fuel injectors and mixed with the compressed core air to provide a fuel-air mixture. This fuel-air mixture is ignited and combustion products thereof flow through and sequentially drive rotation of the HPT rotor 51 and the LPT rotor 52 about the powerplant axis 32. The rotation of the HPT rotor 51 and the LPT rotor 52 respectively drive rotation of the HPC rotor 50 and the LPC rotor 49 about the powerplant axis 32 and, thus, compression of the air received from the core inlet 80. The rotation of the LPT rotor 52 also drives rotation of the propulsor rotor 48. The rotation of the propulsor rotor 48 propels the bypass air through and out of the bypass flowpath 70. The propulsion of the bypass air may account for a majority of thrust generated by the turbine engine 24 of FIG. 1.

While the turbine engine 24 is described above with a particular two rotating structure arrangement, the present disclosure is not limited thereto. For example, the LPC rotor 49 may be omitted to configure the LPT rotor 52 as a power turbine (PT) rotor for the propulsor rotor 48. In another example, the turbine engine 24 may also include another rotating structure; e.g., an intermediate speed spool for the engine core 46.

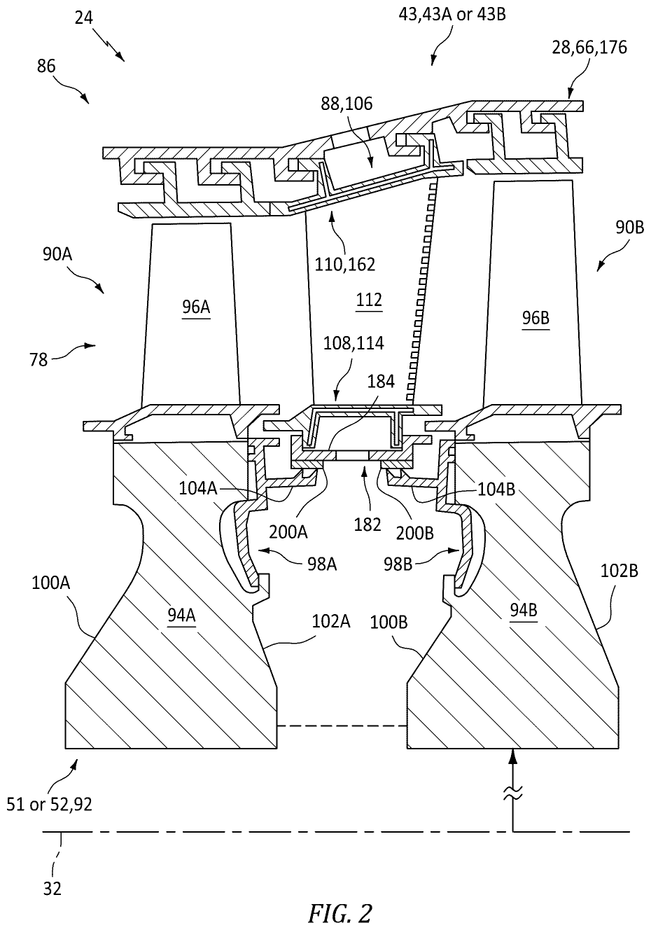

FIG. 2 illustrates an assembly 86 of the turbine engine 24 within the turbine section 43. This turbine section engine assembly 86 includes a circumferentially segmented turbine vane structure 88 (e.g., a turbine vane array) arranged with one or more bladed rotor stages 90A and 90B (generally referred to as “90”) of a turbine rotor 92 along the core flowpath 78. The turbine vane structure 88 may be arranged at various locations along the core flowpath 78 within the turbine section 43. The turbine vane structure 88 of FIG. 2, for example, is arranged between the adjacent rotor stages 90 along the core flowpath 78. With this arrangement, the turbine vane structure 88 may be disposed in the HPT section 43A of FIG. 1, and the turbine rotor 92 may be the HPT rotor 51. Alternatively, the turbine vane structure 88 may be disposed in the LPT section 43B of FIG. 1, and the turbine rotor 92 may be the LPT rotor 52. The turbine vane structure 88 of the present disclosure, however, is not limited to such exemplary arrangements. For example, while the rotor stages 90 are described above as being part of the common turbine rotor 92, it is contemplated the first rotor stage 90A may alternatively be part of the HPT rotor 51 and the second rotor stage 90B may be part of the LPT rotor 52. With such an arrangement, the turbine vane structure 88 may be disposed between the HPT section 43A and the LPT section 43B.

Each rotor stage 90A, 90B of FIG. 2 includes a turbine rotor disk 94A, 94B (generally referred to as “94”), a plurality of turbine rotor blades 96A, 96B (generally referred to as “96”) and at least (or only) one cover plate 98A, 98B (generally referred to as “98”). Each rotor stage 90 and its rotor disk 94 are rotatable about the powerplant axis 32. The rotor disk 94 extends axially along the powerplant axis 32 between opposing axial sides 100A, 100B (generally referred to as “100”) and 102A, 102B (generally referred to as “102”) of the rotor disk 94. The rotor blades 96 are arranged and may be equispaced circumferentially around the powerplant axis 32 in an annular array; e.g., a circular array. Each rotor blade 96 is connected (e.g., mechanically fastened or otherwise attached) to the rotor disk 94. Each rotor blade 96 projects radially outward (e.g., away from the powerplant axis 32) from an outer rim of the rotor disk 94, into and substantially radially across the core flowpath 78, to a radial outer tip of the respective rotor blade 96. The first cover plate 98A is attached to the first rotor disk 94A at the respective disk second side 102A. The second cover plate 98B is attached to the second rotor disk 94B at the respective disk first side 100B. Each of the cover plates 98 of FIG. 2 includes a rotating air seal element 104A, 104B (generally referred to as “104”). This rotating air seal element 104 projects axially along the powerplant axis 32 out from a base of the respective cover plate 98 to an axial distal end of the seal element 104. Each seal element 104 may include one or more knife-edge seal elements disposed along a cantilevered support arm. Each seal element 104 may have a circumferentially non-segmented full-hoop geometry around the powerplant axis 32. The present disclosure, however, is not limited to such an exemplary seal element configuration. For example, the seal element 104 may be replaced by or augmented by a hydrodynamic non-contact seal arrangement.

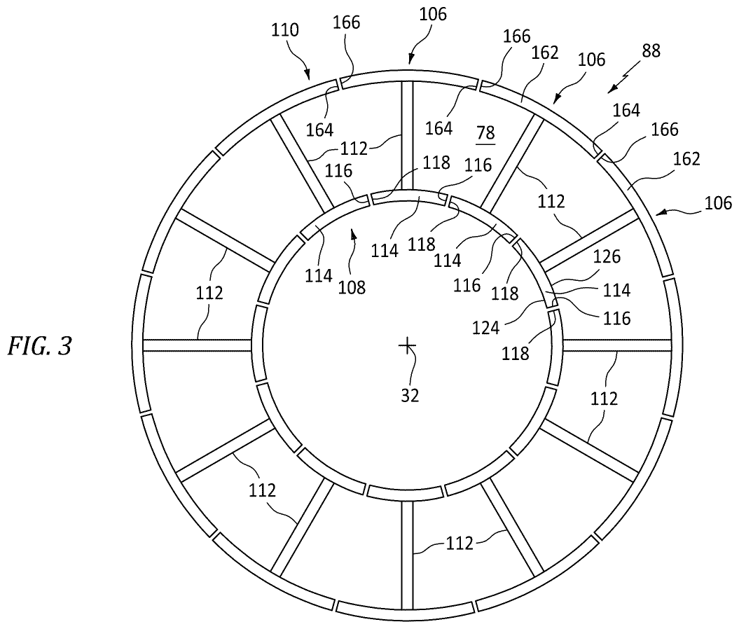

Referring to FIG. 3, the turbine vane structure 88 includes a plurality of vane structure segments 106; e.g., turbine vane singlets. These vane structure segments 106 are arranged side-by-side circumferentially around the powerplant axis 32 in an annular array; e.g., a circular array. With this arrangement, the vane structure segments 106 collectively form and provide the turbine vane structure 88 with a radial inner platform 108, a radial outer platform 110 and an array of stationary turbine vanes 112.

The radial inner platform 108 includes a plurality of inner platform segments 114, where each of these inner platform segments 114 is part of a respective one of the vane structure segments 106. Each of the inner platform segments 114 extends circumferentially about the powerplant axis 32 between opposing circumferential sides 116 and 118 of the respective inner platform segment 114. The inner platform segments 114 are arranged side-by-side circumferentially around the powerplant axis 32 in an annular array; e.g., a circular array. The first side 116 of each inner platform segment 114 is disposed circumferentially next to the second side 118 of a respective circumferentially neighboring (e.g., adjacent) one of the inner platform segments 114. Similarly, the second side 118 of each inner platform segment 114 is disposed circumferentially next to the first side 116 of a respective circumferentially neighboring (e.g., adjacent) one of the inner platform segments 114. With this arrangement, the radial inner platform 108 is provided with a circumferentially segmented full-hoop (e.g., tubular) geometry around the powerplant axis 32.

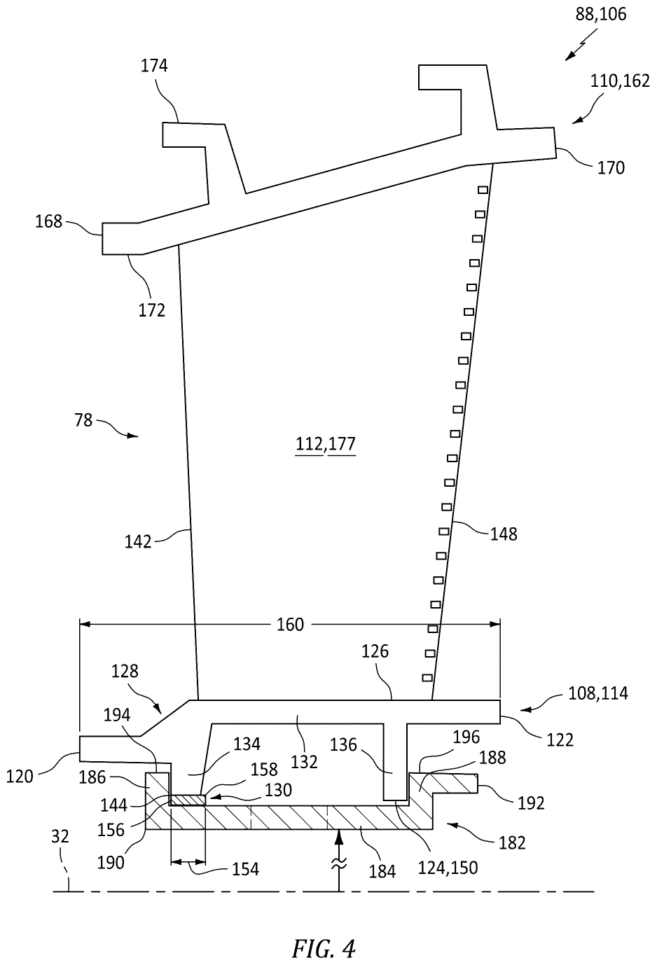

Referring to FIG. 4, the radial inner platform 108 and each of its inner platform segments 114 extend axially along the powerplant axis 32 from a first end 120 (e.g., an upstream end) of the radial inner platform 108 to a second end 122 (e.g., a downstream end) of the radial inner platform 108. The radial inner platform 108 and each of its inner platform segments 114 extend radially from a radial inner side 124 of the radial inner platform 108 to a radial outer side 126 of the radial inner platform 108. At the inner platform outer side 126, the radial inner platform 108 forms a radial inner peripheral boundary of a longitudinal length of the core flowpath 78 which extends through the turbine vane structure 88. Each inner platform segment 114 thereby forms a respective circumferential section of the inner peripheral boundary of the core flowpath 78 along that respective inner platform segment 114.

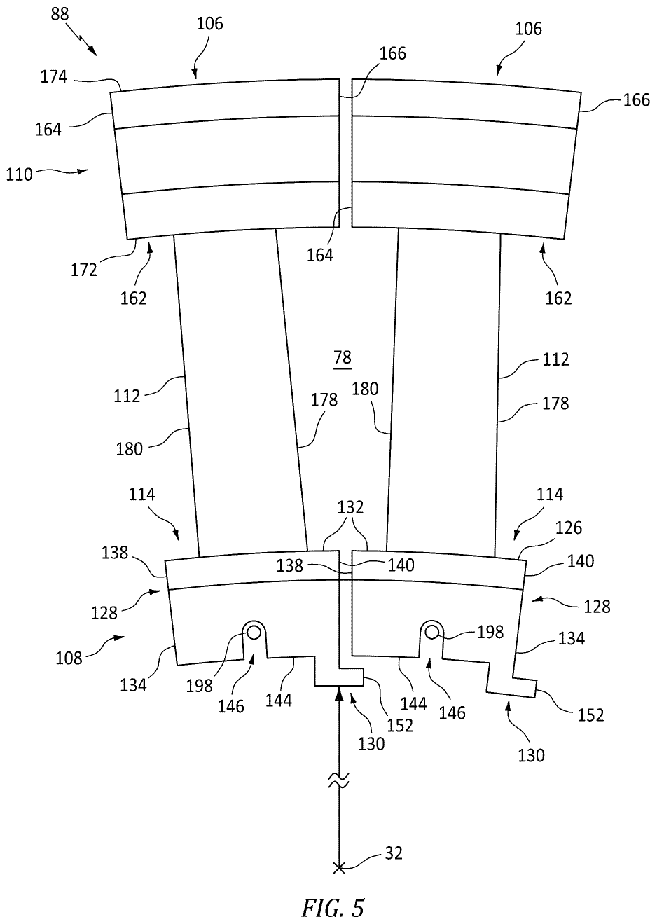

Referring to FIG. 5, each inner platform segment 114 includes an inner platform segment base 128 and an inner platform segment retaining tab 130. The segment base 128 includes an inner platform segment wall 132 and one or more inner platform segment mounting flanges 134 and 136; see also FIG. 4. This segment base 128 and each of its members 132, 134 and 136 extend circumferentially about the powerplant axis 32 between and to the opposing circumferential sides 138 and 140 of the respective inner platform segment 114. The respective inner platform segment first side 138 and the respective inner platform segment second side 140 may thereby also be opposing circumferential sides of the segment base 128 and each of its members 132, 134 and 136.

Referring to FIG. 4, the segment wall 132 extends axially along the powerplant axis 32 between and to the opposing axial ends 120 and 122 of the radial inner platform 108 and the respective inner platform segment 114. The inner platform first end 120 and the inner platform second end 122 may thereby also be opposing axial ends of the segment base 128 and its segment wall 132. The segment wall 132 is disposed at the inner platform outer side 126.

The segment wall 132 thereby forms the respective circumferential section of the inner peripheral boundary of the core flowpath 78 along that respective inner platform segment 114 and its segment base 128.

The first mounting flange 134 is located towards the inner platform first end 120. The first mounting flange 134 of FIG. 4, for example, is axially aligned with or near a vane leading edge 142 of a respective one of the turbine vanes 112 included in the same vane structure segment 106. The first mounting flange 134 is connected to (e.g., formed integral with or otherwise attached to) the segment wall 132. The first mounting flange 134 projects radially inward (e.g., towards the powerplant axis 32) from the segment wall 132 to a distal radial inner end 144 (e.g., edge) of the first mounting flange 134.

Referring to FIG. 5, the first mounting flange 134 is configured with an aperture 146 (e.g., a slot) which projects axially through the first mounting flange 134. This aperture 146 may be located at a circumferential intermediate position (e.g., a midpoint) between the opposing circumferential sides 138 and 140 of the respective inner platform segment 114. The aperture 146 of FIG. 5 projects, in the radially outward direction, partially radially into the first mounting flange 134 from the inner end 144 of the first mounting flange 134 to a radial distal end of the aperture 146. The aperture 146 of FIG. 5 also extends laterally (e.g., circumferentially about the powerplant axis 32, or tangentially to a reference circle circumscribing the powerplant axis 32) within the first mounting flange 134 between opposing lateral sides of the aperture 146.

Referring to FIG. 4, the second mounting flange 136 is located towards the inner platform second end 122. The second mounting flange 136 of FIG. 4, for example, is axially aligned with or near a vane trailing edge 148 of a respective one of the turbine vanes 112 included in the same vane structure segment 106. The second mounting flange 136 is connected to (e.g., formed integral with or otherwise attached to) the segment wall 132. The second mounting flange 136 projects radially inward from the segment wall 132 to a distal radial inner end 150 (e.g., edge) of the second mounting flange 136. Here, the second mounting flange 136 is axially spaced apart form the first mounting flange 134.

Referring to FIG. 5, the retaining tab 130 is disposed at (e.g., on, adjacent or proximate) the inner end 144 of the first mounting flange 134. This retaining tab 130 is connected to (e.g., formed integral with or otherwise attached to) and cantilevered from the first mounting flange 134. The retaining tab 130 projects laterally out from the side 140 of the first mounting flange 134 to a lateral distal end 152 of the retaining tab 130. This retaining tab 130 is sized and configured to extend laterally along an end portion of the segment base 128 and its first mounting flange 134 of the respective circumferentially neighboring inner platform segment 114. Here, the retaining tab 130 is located radially inboard of, but in close radial proximity to, the respective circumferentially neighboring inner platform segment 114. With this arrangement, the retaining tab 130 is operable to limit radial outward movement of the inner platform segment 114 which includes that retaining tab 130.

Referring to FIG. 4, the retaining tab 130 has an overall axial width 154 along the powerplant axis 32. Here, the tab width 154 may be measured as an axial distance between opposing axial sides 156 and 158 of the retaining tab 130. This tab width 154 may be sized equal to or less than one-quarter (¼), one-fifth (⅕) or one-sixth (⅙) of an overall axial length 160 of the respective inner platform segment 114. Here, the inner platform segment length 160 may be measured as an axial distance between the opposing axial ends 120 and 122 of the respective inner platform segment 114. The present disclosure, however, is not limited to such an exemplary dimensional relationship.

Referring to FIG. 3, the radial outer platform 110 includes a plurality of outer platform segments 162, where each of these outer platform segments 162 is part of a respective one of the vane structure segments 106. Each of the outer platform segments 162 extends circumferentially about the powerplant axis 32 between opposing circumferential sides 164 and 166 of the respective outer platform segment 162. The outer platform segments 162 are arranged side-by-side circumferentially around the powerplant axis 32 in an annular array; e.g., a circular array. The first side 164 of each outer platform segment 162 is disposed circumferentially next to the second side 166 of a respective circumferentially neighboring (e.g., adjacent) one of the outer platform segments 162. Similarly, the second side 166 of each outer platform segment 162 is disposed circumferentially next to the first side 164 of a respective circumferentially neighboring (e.g., adjacent) one of the outer platform segments 162. With this arrangement, the radial outer platform 110 is provided with a circumferentially segmented full-hoop (e.g., tubular) geometry around the powerplant axis 32.

Referring to FIG. 4, the radial outer platform 110 and each of its outer platform segments 162 extend axially along the powerplant axis 32 from an upstream end 168 of the radial outer platform 110 to a downstream end 170 of the radial outer platform 110. The radial outer platform 110 and each of its outer platform segments 162 extend radially from a radial inner side 172 of the radial outer platform 110 to a radial outer side 174 of the radial outer platform 110. At the outer platform inner side 172, the radial outer platform 110 forms a radial outer peripheral boundary of the longitudinal length of the core flowpath 78 which extends through the turbine vane structure 88. Each outer platform segment 162 thereby forms a respective circumferential section of the outer peripheral boundary of the core flowpath 78 along that respective outer platform segment 162.

Referring to FIG. 2, the radial outer platform 110 and each of its outer platform segments 162 is mounted to a stationary support structure 176 of the turbine engine 24; e.g., the inner case 66. Each outer platform segment 162 of FIG. 2, for example, is mechanically coupled to the support structure 176 by one or more mounts; e.g., hooks, hangers, etc.

Referring to FIG. 3, the turbine vanes 112 are arranged and may be equispaced circumferentially about the powerplant axis 32 the turbine vane array. This turbine vane array and its turbine vanes 112 are disposed radially between the radial inner platform 108 and the radial outer platform 110. Each of the vane structure segments 106 may be configured with a single one of the turbine vanes 112. However, it is contemplated one, some or all of the vane structure segments 106 may alternatively include two or more of the turbine vanes 112 where, for example, the respective vane structure segment 106 is alternatively configured as a turbine vane doublet or a turbine vane triplet.

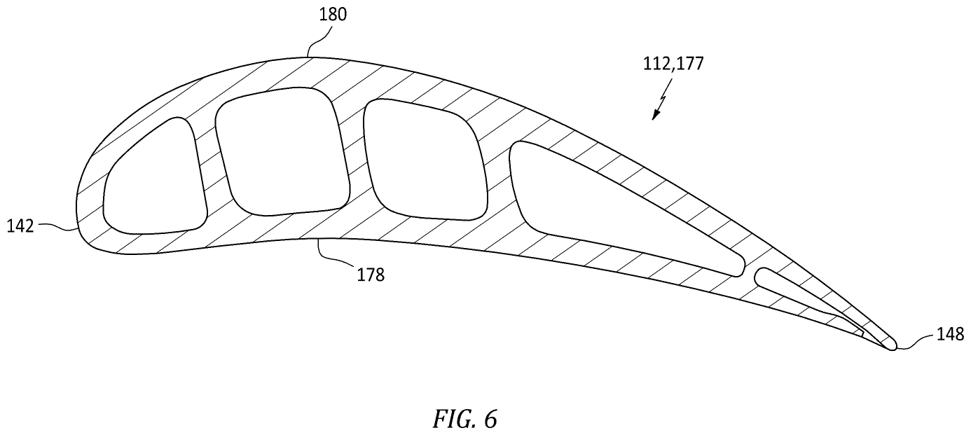

Referring to FIG. 4, each turbine vane 112 is configured as an airfoil 177. Each turbine vane 112 of FIG. 4, for example, extends spanwise (e.g., radially relative to the powerplant axis 32) across the core flowpath 78 from the respective inner platform segment 114 to the respective outer platform segment 162. Each turbine vane 112 is also connected to (e.g., formed integral with or otherwise attached to) the respective inner platform segment 114 and the respective outer platform segment 162. Each turbine vane 112 extends longitudinally (e.g., generally axially along the powerplant axis 32) from the vane leading edge 142 to the vane trailing edge 148, where the vane leading edge 142 is upstream of the vane trailing edge 148 along the core flowpath 78. Referring to FIG. 6, each turbine vane 112 extends between and to opposing lateral sides 178 and 180 of the respective turbine vane 112. The vane first side 178 of FIG. 5 is a concave, pressure side of the respective turbine vane 112. The vane second side 180 of FIG. 5 is a convex, suction side of the respective turbine vane 112. The opposing vane sides 178 and 180 extend longitudinally to and meet at the vane leading edge 142 and the vane trailing edge 148. Referring to FIGS. 4 and 5, each of the vane members 142, 148, 178 and 180 extends spanwise from the respective inner platform segment 114 to the respective outer platform segment 162.

Referring to FIG. 4, the turbine section engine assembly 86 also includes a stationary inner structure 182 (e.g., an inner air seal plate, a tangential on-board injector (TOBI) and/or the like) mated with and radially inboard of the turbine vane structure 88. This inner structure 182 includes a base 184, a first rim 186 and a flanged second rim 188. The inner structure 182 and each of its members 184, 186 and 188 extend circumferentially about (e.g., completely around) the powerplant axis 32. The inner structure 182 and each of its members 184, 186 and 188 may thereby each have a circumferentially non-segmented full-hoop geometry around the powerplant axis 32. The inner structure 182 extends axially along the powerplant axis 32 between opposing axial ends 190 and 192 of the inner structure 182. The first rim 186 is connected to (e.g., formed integral with or otherwise attached to) the inner structure base 184.

This first rim 186 projects radially outward from the inner structure base 184 to a distal radial outer end 194 of the first rim 186. The second rim 188 is axially spaced apart from the first rim 186. The second rim 188 is connected to (e.g., formed integral with or otherwise attached to) the inner structure base 184. This second rim 188 projects radially outward from the inner structure base 184 to a distal radial outer end 196 of the second rim 188. At this outer end, the second rim 188 may include a cantilevered flange.

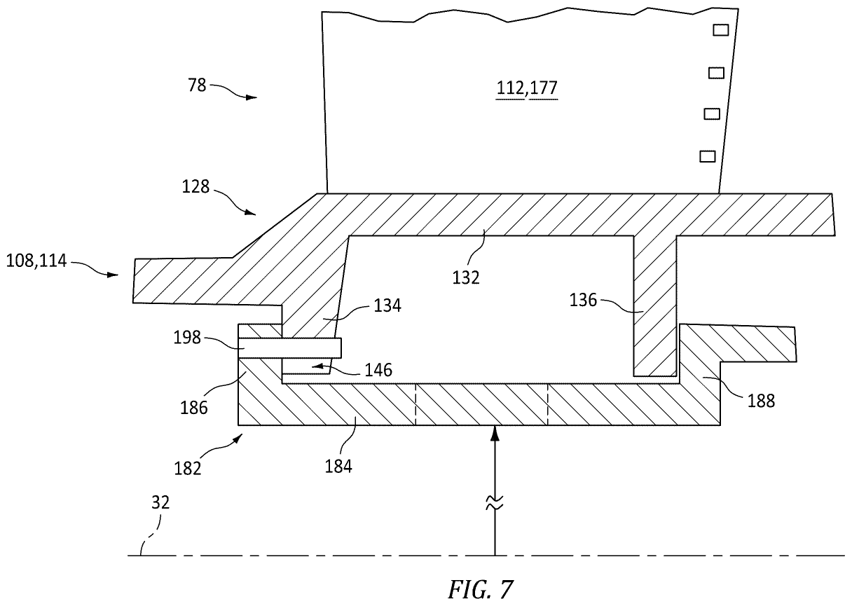

The inner structure 182 is mated with the turbine vane structure 88. The mounting flanges 134 and 136 of each vane structure segment 106, for example, may project radially into an annular channel formed by and extending axially between the inner structure rims 186 and 188. The first mounting flange 134 of FIG. 4 is axially next to and may (or may not) axially engage the first rim 186. The second mounting flange 136 of FIG. 4 is axially next to and may (or may not) axially engage the second rim 188. In addition to this tongue-and-groove like coupling, referring to FIG. 7, the inner structure 182 may be configured with a plurality of pins 198 (one visible in FIG. 7), where each of these pins 198 projects axially out from the inner structure 182 and its first rim 186 into a respective aperture 146. This pin 198 may circumferentially locate each vane structure segment 106 circumferentially relative to the inner structure 182. The pin 198 may also limit radial inward movement of the inner platform segment 114 which includes the respective aperture 146. Thus, when the turbine vane structure 88 and the inner structure 182 are assembled in the turbine engine 24, each inner platform segment 114 of FIG. 5 is radially captured in position by (a) the respective retaining tab 130 in the radial outward direction and (b) the respective pin 198 in the radial inward direction. Thus, even in a very unlikely event of a turbine vane failure (e.g., vane burnup, vane fracture, etc.), the respective inner platform segment 114 will remain in place without entering the core flowpath 78.

In some embodiments, the pins 198 of FIG. 7 may be mechanically fastened to the inner structure 182 and its first rim 186. In other embodiments, it is contemplated the pins 198 may be formed as integral protrusions of the inner structure 182.

Referring to FIG. 2, each seal element 104A, 104B is disposed radially inboard of a respective seal land 200A, 200B (generally referred to as “200”) on the inner structure 182 and its base 184. Each seal element 104 is also sealingly engaged with the respective seal land 200.

In some embodiments, each vane structure segment 106 may be formed as a monolithic body. The respective inner platform segment 114, the respective outer platform segment 162 and the respective turbine vane 112 (or vanes), for example, may be cast, machined, additively manufactured and/or otherwise formed as a single unitary body. The present disclosure, however, is not limited to such an exemplary vane structure segment construction.

For example, in other embodiments, it is contemplated some or all of the vane structure segment members 112, 114 and/or 162 may be discretely formed and subsequently connected together (e.g., welded or otherwise bonded together) following the formation thereof.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

1. An assembly for a turbine engine, comprising:
a vane structure including a plurality of structure segments arranged circumferentially about an axis, each of the plurality of structure segments including
an inner platform segment including a base and a tab, the base forming a respective circumferential section of an inner peripheral boundary of a flowpath through the vane structure, and the tab connected to and projecting laterally out from the base, wherein the tab is radially next to and extends laterally along the base of the inner platform segment of a respective circumferentially neighboring one of the plurality of structure segments;
an outer platform segment forming a respective circumferential section of an outer peripheral boundary of the flowpath through the vane structure; and
an airfoil extending radially across the flowpath and connected to the inner platform segment and the outer platform segment; and
an inner structure extending circumferentially around the axis, the inner structure configured with a plurality of pins, and each of the plurality of pins projecting axially into an aperture in the base of a respective one of the plurality of structure segments.

2. The assembly of claim 1, wherein the tab is configured to limit radial outward movement of the inner platform segment that includes the tab.

3. The assembly of claim 1, wherein the tab is radially inboard of the base of the inner platform segment of the respective circumferentially neighboring one of the plurality of structure segments.

4. The assembly of claim 1, wherein an axial width of the tab is equal to or less than one-quarter of an axial length of the base.

5. The assembly of claim 1, wherein the base includes a wall and a first flange;
the wall forms the respective circumferential section of the inner peripheral boundary of the flowpath through the vane structure;
the first flange projects radially inward from the wall to an inner end of the first flange, and the first flange extends circumferentially about the axis between opposing circumferential sides of the wall; and
the tab is connected to the first flange at the inner end of the first flange.

6. The assembly of claim 5, wherein the base further includes a second flange projecting radially inward from the wall to an inner end of the second flange, the second flange extends circumferentially about the axis between the opposing circumferential sides of the wall, and the second flange is axially spaced from the first flange.

7. (canceled)

8. The assembly of claim 1, wherein each of the plurality of structure segments is configured as a singlet vane structure.

9. The assembly of claim 1, wherein each of the plurality of structure segments is formed as a monolithic body.

10. The assembly of claim 1, wherein the inner structure comprises a full-hoop body.

11. The assembly of claim 1, wherein the inner structure comprises a stationary air seal land.

12. The assembly of claim 11, further comprising:
a rotor disk rotatable about the axis;
a plurality of rotor blades arranged circumferentially about the axis and connected to the rotor disk, each of the plurality of rotor blades projecting radially into the flowpath; and
a rotating air seal element connected to the rotor disk, the rotating air seal element radially below and sealingly engaged with the stationary air seal land.

13. The assembly of claim 1, wherein the plurality of pins are mechanically fastened to the inner structure.

14. The assembly of claim 1, wherein the aperture comprises a slot.

15. The assembly of claim 1, wherein the aperture projects in a radial outward direction partially into the base of the respective one of the plurality of structure segments, and the aperture extends laterally within the base of the respective one of the plurality of structure segments.

16. The assembly of claim 1, wherein each of the plurality of pins is configured to limit radial inward movement of the base of the respective one of the plurality of structure segments.

17. The assembly of claim 1, wherein the vane structure is a turbine vane structure.

18. The assembly of claim 1, further comprising:
a first bladed rotor stage rotatable about the axis, the first bladed rotor stage including a first rotor disk and a plurality of first rotor blades, and each of the plurality of first rotor blades projecting radially into the flowpath; and
a second bladed rotor stage rotatable about the axis, the second bladed rotor stage including a second rotor disk and a plurality of second rotor blades, and each of the plurality of second rotor blades projecting radially into the flowpath;
the vane structure axially between and adjacent the first bladed rotor stage and the second bladed rotor stage.

19. (canceled)

20. An assembly for a turbine engine, comprising:
a plurality of structure segments arranged circumferentially about an axis to form a vane structure, each of the plurality of structure segments including an inner platform segment, an outer platform segment and an airfoil;
the inner platform segment including a wall, a flange and a tab, the wall forming a respective circumferential section of an inner peripheral boundary of a flowpath through the vane structure, the flange projecting radially inward towards the axis from the wall to an inner end of the flange, the flange extending circumferentially about the axis between opposing circumferential sides of the inner platform segment, and the tab connected to and projecting laterally out from the flange, wherein the tab is radially adjacent, inboard of and extends laterally along the flange of the inner platform segment of a respective circumferentially neighboring one of the plurality of structure segments;
the outer platform segment forming a respective circumferential section of an outer peripheral boundary of the flowpath through the vane structure; and
the airfoil extending radially across the flowpath and connected to the inner platform segment and the outer platform segment.
